(19) United States
(12) Patent Application Publication
(10) Pub. No.: US 2011/0091822 A1
(43) Pub. Date: Apr. 21, 2011

(54) THERMAL PROCESSOR EMPLOYING A TEMPERATURE COMPENSATION SYSTEM

(76) Inventors: JOHN R. SCUFSA, INVER GROVE HEIGHTS, MN (US); DAVID J. MCDANIEL, VADNAIS HEIGHTS, MN (US); CURT A. WIENS, ST. PAUL, MN (US)

(21) Appl. No.: 09/144,927

(22) Filed: Mar. 12, 2007

(51) Int. Cl. G03C 5/00; G03B 15/00

(52) U.S. Cl. 430/350; 396/575

(57) ABSTRACT

A thermal processor for use in developing an image in an imaging material which is transported along a transport path through the thermal processor. The thermal processor includes a preheat assembly for preheating the thermally processable material to the threshold temperature. The preheat assembly includes a heated member having a major surface facing the thermally processable material. A dwell assembly is provided for thermal development of the image in the thermally processable material. Means are provided for moving the thermally processable material along the transport path through the preheat assembly and the dwell assembly including a roller assembly which contacts the thermally processable material. The roller assembly includes rollers positioned between the heated member and the thermally processable material. Means are provided for reducing optical density loss in the thermally processable material, including means for selectively changing the temperature of the heated member as the thermally processable material moves along the transport path.

### CROSS-REFERENCE TO RELATED APPLICATIONS

This patent application is related to U.S. patent application Ser. No. ______ (Attorney Docket No. 1200.122.101), entitled “Apparatus for Cooling a Thermally Processed Material” filed on Aug. 31, 1998, and assigned to the same Assignee.

### TECHNICAL FIELD

The present invention generally relates to an apparatus and method for thermal processing a material, and more particularly relates to an apparatus and method for thermal processing a thermally processable material employing a temperature compensation system to reduce downweb optical density loss.

### BACKGROUND OF THE INVENTION

Various medical, industrial, and graphic imaging applications require the production of very high quality images. One way to produce high quality images is through the use of a photothermographic processor. One type of photothermographic processor uses a thermally processable, light-sensitive photothermographic film that typically includes a thin polymer or paper base coated with an emulsion of dry silver or other heat sensitive material. This photothermographic film may take the form of short sheets, longer lengths, or continuous rolls of photothermographic material. These sheets, lengths, and rolls are often referred to as photothermographic elements, thermal imaging material or thermally processable material.

A photothermographic processor generally includes a photothermographic element exposure system, a thermal processing mechanism and a cooling apparatus. The exposure system typically employs a laser scanner device that produces laser light that exposes the imaging material to form a latent image thereon or therein. The thermal processing mechanism is used to thermally develop this image. To develop the latent image, the thermal processing mechanism heats the exposed imaging material to at least a threshold development temperature for a specific period of time to develop the image within the imaging material. Subsequently, the imaging material must be cooled by the cooling apparatus of the photothermographic processor to allow a user to hold the element while examining the developed image.

In the thermal processor, the density of the developed image is dependent upon the precise and uniform transfer of heat to the thermally processable material (film emulsion). Non-uniform heating can produce an unevenly developed image having a non-uniform density. In particular, the transient-temperature history of photothermographic film as it is processed is critical to maintaining optical densities in the media. Any change in the amount of time that the media dwells at the processing temperature can have adverse effects on the optical densities of the media.

One known type of thermal processor capable of processing large sheets or “galleys” of thermally processable material is commonly termed a “flat-bed processor”. In summary, this type of thermal processor generally includes a preheat section, a dwell section, and a cooling section. The thermally processable material follows a transport path through the preheat section where it is heated to at least approach a threshold temperature necessary for development, through the dwell section where development of the image in the thermally processable material occurs, and through the cooling section for cooling of the thermally processable material.

High thermal conductivity rollers may be used to transport the thermally processable material through the thermal processor along the transport path. One known problem with flat-bed processors with high thermal conductivity rollers is that the rollers in the preheat section of the thermal processor can lose heat to the thermally processable material more rapidly than the rollers are heated by heating plates located within the thermal processor. The imbalance of heat flow causes the temperature of the preheat rollers to drop. When the temperatures of the preheat rollers decrease, the thermally processable material sees less overall heat energy which may cause an optical density loss in the thermally processable material. One known cause of the loss in heat transfer is due to an air gap of low conductivity between the heating plate and the high thermal conductivity rollers, such that the transfer of heat from the plates to the rollers occurs less rapidly than from the rollers to the thermally processable material. Accordingly, this imbalance affects the transient-temperature history of the media and therefore changes the optical densities in the developed media.

As previously indicated, downweb density loss in thermal processors, and in particular thermal processors employing a high thermal conductivity rollers, is caused by an imbalance in heat transfer from the heated plate to the rollers and from the rollers to the thermally processable material. As more material is processed, the rollers are losing more heat to the thermally processable material then is provided by the heater plate. The rate at which heating plates recharge the lost energy is the most significant in the preheat section, where the film is being heated from room temperature to about the threshold development temperature of the film (i.e., the dwell temperature or the desired processing temperature of the film.) (e.g., 110° C.).

The heat energy passed to the roller equals the change in internal energy of the roller plus heat energy removed or heat energy passed out of the roller. It is desirable to control the heat passed out of the roller to be constant.

When there is a large difference in film to roller temperature (e.g., in the preheat section of the thermal processor), a significant difference in plate to roller temperature is required in order to maintain equilibrium. Therefore, for a standard system where the heater plate and film temperatures are approximately constant, the roller temperature decreases until an equilibrium point is reached. The lower roller temperature reduces overall heat transfer to the film, causing a downweb density loss.

Downweb density loss has been a concern not only in single galleys, but also in consecutive sheets. The fall-off in a single galley increases with the amount or length of film processed. For a single sheet, the loss is a substantially linear function. The problem of non-uniformity may be further magnified in the thermal processing of consecutive sheets of film.

One known method for correcting downweb density loss is by speed correction to increase dwell time. It may not be desirable to reduce downweb density loss in consecutive sheets in a flat bed processor by a simple speed correction. This density loss may vary according to the time between processing films. Further, increasing the dwell time for each consecutive sheet or galley of film may result in an undesirable increase in film processing time.

For reasons stated above and for other reasons presented in greater detail in the description of the preferred embodiments section of the present invention, a thermal processor is desirable which reaches the processing or threshold temperature at the proper time within the preheat section, allowing the media to dwell for the necessary amount of time and therefore maintaining uniform optical densities throughout the thermally processable material (i.e., reducing downweb density loss). Further a relatively inexpensive and simple method of reducing optical density loss for large sheets of thermally processable material in a flat-bed thermal processor is desired.

### SUMMARY OF THE INVENTION

The present invention provides an apparatus and method for thermal processing a thermally processable material, which employs a temperature compensation system to reduce a downweb density loss. The present invention provides for thermal processing of relatively long sheets or galleys of thermally processable material without sacrificing optical density loss as a percentage of dot pitch, through selectively changing the temperature of the heated member in the preheat assembly of the thermal processor, thereby reaching a desired threshold temperature for development of the thermally processable material at the critical time.

In one embodiment, the present invention provides a thermal processor for use in developing an image in a thermally processable material which is transported along a transport path through the thermal processor. The thermal processor includes a preheat assembly for preheating the thermally processable material to a threshold temperature. The preheat assembly includes a heated member having a major surface facing the thermally processable material. A dwell assembly is provided for thermal development of the image in the thermally processable material. Means are provided for moving the thermally processable material along the transport path through the preheat assembly and the dwell assembly, including a roller assembly which contacts the thermally processable material. The roller assembly includes rollers positioned between the heated member and the thermally processable material. Means are provided for reducing optical density loss in the thermally processable material, including means for selectively changing the temperature of the heated member as the thermally processable material moves along the transport path.

In one aspect, the rollers are nested within the heated member. The rollers are made of a relatively high thermal conductivity material, which in one embodiment includes a coating made of silicon. The means for selectively changing the temperature of the heated member includes means for selectively increasing the temperature of the heated member as the thermally processable material moves along the transport path, allowing the thermally processable material to reach the threshold temperature at the proper time.

The means for selectively changing the temperature of the heated member may include a position sensing system having an output signal representative of the position of the thermally processable material as it moves along the transport path. In controllers responsive to the position output signal for selectively changing the temperature of the heated member.

In one aspect, the controller includes a table stored in memory, wherein the table includes values corresponding to a desired change in temperature of the heated member based on the position output signal. In one aspect, the means for selectively changing the temperature of the heated member may include a computer program stored in memory.

In one aspect, the thermally processable material includes a leading edge and a trailing edge. The position sensing system further includes a first sensor having a first output signal representative of the position of the leading edge the thermally processable material along the transport path. In another aspect, the thermally processable material includes a leading edge and a trailing edge, and the position sensing system further includes an entrance sensor having a first output signal representative of the leading edge entering the thermal processor, and a second output signal representative of the trailing edge of the film entering the thermal processor. The position sensing system may further include an exit sensor having a first output signal representative of the leading edge exiting the thermal processor and a second output signal representative of the trailing edge exiting the thermal processor.

In another embodiment, the present invention provides a method for developing an image in a thermally processable material transported along a transport path through a thermal processor. The thermal processor includes a preheat assembly for preheating the thermally processable material to a threshold temperature. The dwell assembly is provided for thermal development of the image in the thermally processable material. The thermally processable material is defined by a leading edge and a trailing edge. The method includes the step of operating a roller assembly to move the thermally processable material through the preheated assembly, including the step of contacting the thermally processable material with the roller assembly to move the thermally processable material along the transport path. The thermally processable material is heated as it moves along the transport path through the preheat assembly using a heated member, wherein the roller assembly includes rollers positioned between the heated member and the thermally processable material. The temperature of the heated member is changed as the thermally processable material moves along the transport path reducing optical density loss in the thermally processable material.

In one aspect, the rollers are nested within the heated member, without contacting the heated member. The step of changing the temperature of the heated member includes the step of increasing the temperature of the heated member as the thermally processable material moves along the transport path, allowing the thermally processable material to reach the threshold temperature at the proper time.

The method further includes the step of sensing the position of the thermally processable material using a position sensing system as the thermally processable material moves along the transport path. A position output signal is provided to a processor controlled system, wherein the position output signal is representative of the position of the thermally processable material along the transport path. The temperature of the heated member is changed in response to the position output signal. The step of changing the temperature of the heated member may include the step of storing a table in memory in a processor control system, wherein the table includes values correlating a desired change in temperature of the heated member based on the sensed position output signal. The step of changing the temperature of heated member in response to the position output signal may include the step of accessing a computer program stored in memory in the processor control system. The step of sensing the position of the thermally processable material may include the step of providing an entrance sensor having an output signal representative of the position of the leading edge as it enters the thermal processor. The step of sensing the position of the thermally processable material includes a step of providing an entrance sensor having a first output signal representative of the position of the leading edge of the thermally processable material entering the thermal processor and a second output signal representative of the position of the trailing edge of the imagining material entering the thermal processor. The step of sensing the position of the thermally processable material may further include the step of providing an exit sensor having a first output signal representative of the leading edge exiting the thermal processor and a second output signal representative of the trailing edge exiting the thermal processor.

In another embodiment, the present invention provides a thermal processor for use in developing an image in a thermally processable material which is transported along a transport path through the thermal processor. The thermal processor includes a preheat assembly for preheating the thermally processable material to a threshold temperature. The first heated member includes a major surface facing the thermally processable material. A transport system is provided including a roller assembly positioned about the thermally processable material which contacts the thermally processable material for moving the thermally processable material along the transport path. The roller assembly includes a plurality of rollers positioned between the first heated member and the thermally processable material. A thermal processor control system is provided which is operably coupled to the first heated member in the transport system. The thermal processor control system includes a controller for selectively changing the temperature of the heated member as the thermally processable material moves along the transport path.

In one aspect, the rollers are made of a high thermal conductivity material which in one embodiment is foam. In one embodiment, the rollers are coated with the high thermal conductivity material which more preferably is silicone. The rollers which contact the thermally processable material are spaced from the heated member.

In another aspect, a second heated member is located adjacent the first heated member to define separately heatable zones, wherein the first heated member and the second heated member are heated independent of each other. The thermal processor is a flat-bed processor.

The thermal processor may include an entrance sensor, wherein the entrance sensor provides and output signal to the controller representative of the position of the thermally processable material along the transport path. The output signal may include a first output signal representative of the leading edge of the thermally processable material entering the thermal processor and a second output signal representative of the trailing edge of the thermally processable material entering the thermal processor. The controller is responsive to the first output signal for increasing the temperature of the heated member. The controller is responsive to the second output signal for increasing the temperature of the heated member.

The thermal processor may further include an exit sensor, wherein the exit sensor provides and output signal to the controller representative of the position of the thermally processable material along the transport path. The output signal includes a first output signal representative of the leading edge of the thermally processable material exiting the thermal processor. In one aspect the controller is responsive to the first output signal for increasing the temperature of the heated member.

### BRIEF DESCRIPTION OF THE DRAWINGS

The accompanying drawings are included to provide a further understanding of the present invention and are incorporated in and constitute a part of the specification. The drawings illustrate the embodiments of the present invention and together with the description serve to explain the principals of the invention. Other embodiments of the present invention and many of the intended advantages of the present invention will be readily appreciated as the same become better understood by reference to the following detailed description when considered in connection with the accompanying drawings, in which like reference numerals designate like parts throughout the FIG. thereof, and wherein:

FIG. 1 a side-sectional view of a thermal processor employing a temperature compensation system in accordance with the present invention.

FIG. 2 is a partial perspective view illustrating one exemplary embodiment of a roller employed in the roller assembly of the thermal processor of FIG. 1.

FIG. 3 is a graph plotting temperature (° F.) versus distance modeling theoretical film temperature loss for various lengths of thermally processable material, as the material moves through the preheat, dwell, and cooling section of a thermal processor.

FIG. 4 is a block diagram illustrating one exemplary embodiment of a thermal processor control system for a thermal processor employing a temperature compensation system in accordance with the present invention.

FIG. 5 is a block diagram illustrating another exemplary embodiment of a thermal processor control system for a thermal processor employing a temperature compensation system in accordance with the present invention.

FIG. 6 is a side-sectional view illustrating another exemplary embodiment of a thermal processor employing a temperature compensation system in accordance with the present invention.

FIG. 7 is a block diagram illustrating another exemplary embodiment of a thermal processor control system for a thermal processor employing a temperature compensation system in accordance with the present invention.

FIG. 8 is a flow diagram illustrating one method of developing an image in a thermally processable material transported through a thermal processor, employing a temperature compensation system in accordance with the present invention.

FIG. 9 is a flow diagram illustrating another exemplary embodiment of a method for developing an image in a thermally processable material transported through a thermal processor, employing a temperature compensation system in accordance with the present invention.

FIG. 10 is a graph of temperature (° C.) versus feet of film processed illustrating one exemplary embodiment of a thermal processor employing a temperature compensation system in accordance with the present invention for a 20 foot galley of film.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

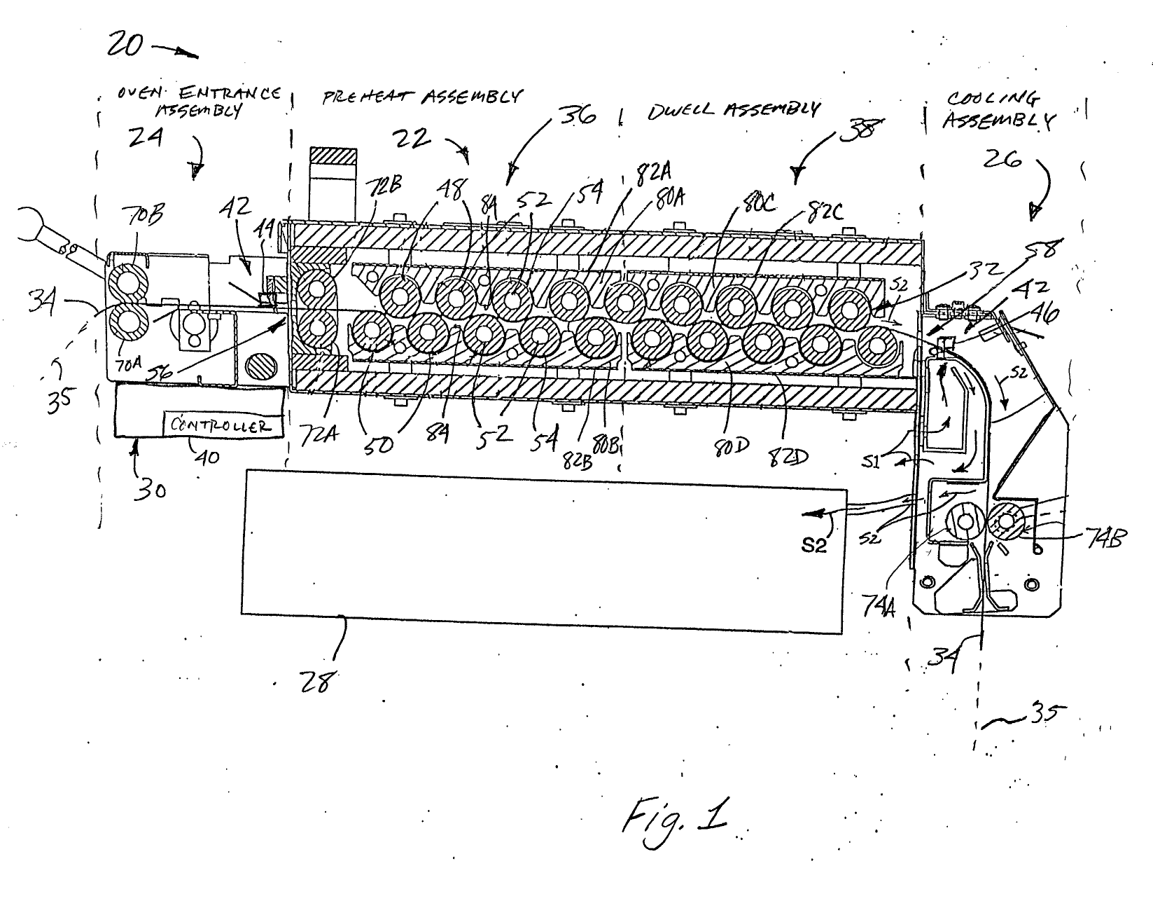

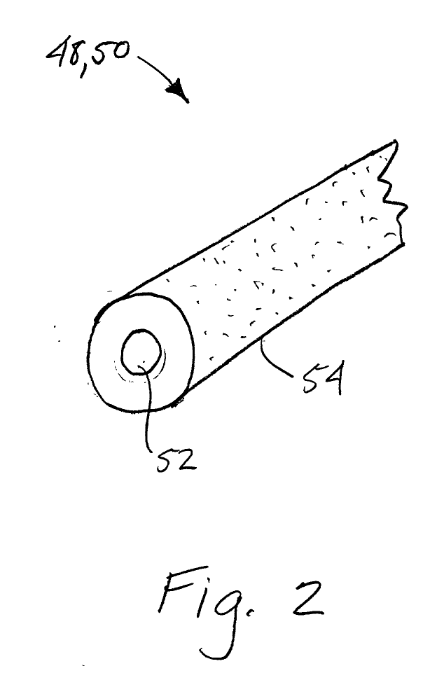

In FIG. 1, a thermal processor 20 in accordance with the present invention is generally shown. The thermal processor 20 can be part of a photothermographic processing system. The thermal processor 20 in accordance with the present invention includes the temperature compensation system for reducing downweb density loss and maintaining optical densities. The thermal processor in accordance with the present invention is especially useful for long galleys of thermally processable material and/or the processing of consecutive sheets or galleys of thermally processable material.

Thermal processor 20 includes a heated enclosure or oven 22, an oven entrance assembly 24, a cooling assembly 26, a filtering system 28, and a thermal processor control system 30. A transport system 32 is provided for moving a thermally processable material 34 along a transport path 35 through the oven entrance assembly 24, through a preheat assembly 36 of the oven 22 where the thermally processable material 34 is heated to at least approach a threshold temperature necessary for development, through a dwell assembly 38 of the oven 22 where development of the thermally processable material 34 occurs, and through cooling assembly 26 for cooling of the thermally processable material 34.

Examples of thermally processable material includes thermographic or photothermographic film (a film having a photothermographic coating or emulsion on at least one side). The term thermally processable material or “imaging material” or film as used herein includes any material in which an image can be captured, including medical imaging films, graphic art films, thermally processable materials used for data storage and the like. In one preferred embodiment, the thermally processable material is an up to 18 inch wide photothermalgrahic film having, for example, a 4-mil (0.01 centimeter) polyester base. The composition of such a film is disclosed in pending U.S. patent application Ser. Nos. 08/529,982; 08/530,024; 08/530,066; and 08/530,744 (assigned to 3M Company, St. Paul, Minn., U.S.A.). This film can be useful as an imagesetting film, the length of which can vary from shorter sheets to longer lengths or galleys on rolls. Alternatively, the thermally processable material can be a photothermographic sheet film, such as a 14-inch (35.6-centimeter) by 17-inch (43.2-centimeter) sheet of medical imaging film having a 7-mil (0.018 centimeter) polyester base (e.g., DRYVIEW DVC or DVB medical imaging film available from Imation Corporation, Oakdale, Minn., U.S.A).

Thermal processor control system 30 operates to control the operating parameters of thermal processor 20 for development of an image in the thermally processable material 34 while maintaining desired optical densities of the image developed therein. The thermal processor control system 30 operates to detect and control the control parameters associated with thermal processor 20. Thermal processor control system 30 can include a microprocessor based controller or other device such as a computer, capable of performing a sequence of logical operations. The thermal processor control system 30 includes a film position detection system 42 capable of detecting the position of the thermally processable material along the transport path 33. In one exemplary embodiment shown, the thermally processable material position detecting system 42 includes an entrance sensor 44 and an exit sensor 46. Entrance sensor 44 provides a first output signal to controller 40 representative of the leading edge of the thermally processable material 34 entering the oven 22, and provides a second output signal to controller 40 representative of the trailing edge of the thermally processable material entering the oven 22. Similarly, exit sensor 46 provides a first output signal to controller 40 representative of the leading edge of the thermally processable material 34 exiting the oven 22, and a second output signal to controller 40 representative of the trailing edge of the thermally processable material 34 exiting oven 22. The operation of the thermal processor control system 30 as part of a temperature compensation system for reducing downweb density loss in accordance with the present invention is described in detail later in the specification.

Transport system 32 includes a plurality of upper rollers 48 and lower rollers 50 arranged in a corrugated pattern. Referring also to FIG. 2, upper rollers 48 and lower rollers 50 can include support rods 52 with cylindrical sleeves of a support material 54 which surrounds the external surface of the rods 52. In one preferred embodiment, the support material is a high conductivity material, and more preferably, the support material includes silicone. In another embodiment, the support material 54 can be a foam material (e.g., a melamine foam material having a lower thermal conductivity relative to silicone). The support rods 52 are rotatably mounted to the opposite sides of oven 22 to orient the upper rollers 48 and lower rollers 50 in a spaced relationship about the transport path between an oven entrance 56 and an oven exit 58. The rollers 48 and 50 are positioned to contact the thermally processable material 34, and move it along the transport path 35.

One or more of the rollers 48 and 50 of the transport system 32 can be driven in order to drive the thermally processable material 34 through the oven 22 of thermal processor 20. In one preferred embodiment, all of the lower rollers 50 and upper rollers 48 are drive rollers. Alternatively, the lower rollers 48 may be drive rollers while the upper rollers 48 may be driven or idler rollers.

Transport system 32 further includes a pair of primary nip rollers 70A and 70B. The lower nip rollers 70A is a drive roller while the upper nip roller 70B is a driven or idler roller. Adjacent to the oven entrance 56 is a pair of oven nip rollers 72A and 72B. The lower nip roller 72A is a drive roller while the upper nip roller 72B is a driven or idler roller. Similarly, cooling assembly 26A includes a pair of nip rollers 74A and 74B. The lower nip roller 74A is a drive roller while the upper nip roller 74B is a driven or idler roller. All of the drive rollers may be operably connected, either through a gear system, pulley system, or other mechanical means to a central drive system (driven by a motor not shown) for rotating the drive rollers during operation of thermal processor 20. In one embodiment, the transport system 32 operates as disclosed in U.S. patent application Ser. No. (Attorney Docket No. 1200.122.101) entitled “Apparatus for Cooling a Thermally Processable Material”, previously incorporated by reference herein. In this embodiment, the rollers of cooling assembly 26 are driven faster than the other rollers in the thermal processor 20 to maintain desired tension on the thermally processable material. The above-referenced patent application is incorporated herein by reference.

Preheat assembly 36 includes heated members 80A, 80B and dwell assembly 36 includes heated members 80C, 80D. The heated members 80A, 80B, 80C, 80D are heated via corresponding blanket heaters 82A, 82B, 82C, 82D of the thermal processor 20 operably coupled thereto. Blanket heaters 82A, 82B, 82C, 82D are operably controlled by the thermal processor control system 30. Heated members 80A, 80B, 80C, 80D operate to transfer heat via rollers 48-50 to the thermally processable material 34 for developing an image therein as the thermally processable material 34 is moved along the transport path. As described in detail herein, heated members 80A, 80B, 80C and 80D may be selectively controlled individually or in groups to change the amount of heat transferred to the thermally processable material via rollers 48, 50 to maintain required heat transferred to the thermally processable material in the preheat assembly 36.

In one preferred embodiment shown, rollers 48 and 50 extend through the preheat assembly and dwell assembly. Alternatively, rollers 48-50 may only extend through the preheat assembly or may only extend partially into the dwell assembly. Heated member 80A, 80B, 80C, 80D include a first major surface 84 which faces the thermally processable material 34 transport path 35. The major surface 84 is geometrically configured such that rollers 48, 50 are “nested” within a corresponding heated member 80A, 80B, 80C, 80D. Although nested within a corresponding heated member 80A, 80B, 80C, 80D, rollers 48, 50 preferably are spaced from the major surface 84 allowing rotational movement of rollers 48, 50 relative to their respective heated members 80A, 80B, 80C, 80D. Rollers 48, 50, in turn, contact the thermally processable material 34 as it moves along the transport path 35. Rollers 48, 50 operate to both move the thermally processable material 34 along the transport path 35 and to transfer heat energy to the thermally processable material 34.

Due to the spacing between the heated members 80A, 80B, 80C, 80D and rollers 48, 50, and the rollers being formed of a high thermal conductivity material, the heat transfer from the heated members 80A, 80B, 80C, 80D to the rollers 48, 50 is not equivalent to the heat transfer from the rollers 48, 50 to the thermally processable material 34. This imbalance in the transfer of heat becomes greater as the length of thermally processable material 34 is processed by the thermal processor 20 increases.

The thermal processor 20 in accordance with the present invention employs a temperature compensation system to compensate for the imbalance in heat transfer, thereby reducing downweb density losses in the thermally processable material 34.

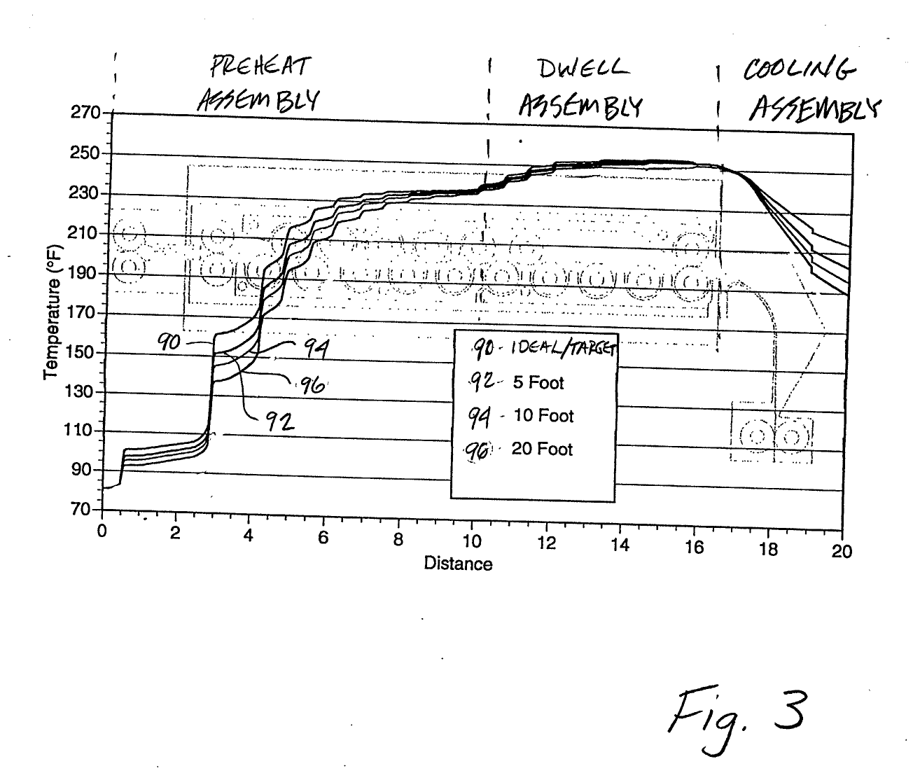

In FIG. 3, a diagram modeling film temperature versus distance as it moves through a thermal processor is illustrated. The various graphs 90, 92, 94 and 96 illustrate the temperatures of various lengths of film and temperature losses associated with those lengths of film in the preheat assembly, dwell assembly, and cooling assembly of a thermal processor (or the amount of temperature compensation required to maintain optical densities). At 90, one exemplary embodiment of a target or threshold temperature graph for development of a thermally processable material in a thermal processor is illustrated. At 92, 94, 96 the temperature losses relative to the target threshold temperatures 90 are illustrated for a 5 foot galley, 10 foot galley, and 20 foot galley of film respectively. During thermal processing, it is very important to reach the desired threshold temperature at the right time and for the correct dwell time in order to obtain the desired optical densities in the developed image. Accordingly, the thermal processor in accordance with the present invention employs a temperature compensation system which adjusts or moves (i.e., compensates) for the temperature losses associated with the imbalance in heat transfer between the heated member and the thermally processable material to meet the temperature characteristics of the target graph 90.

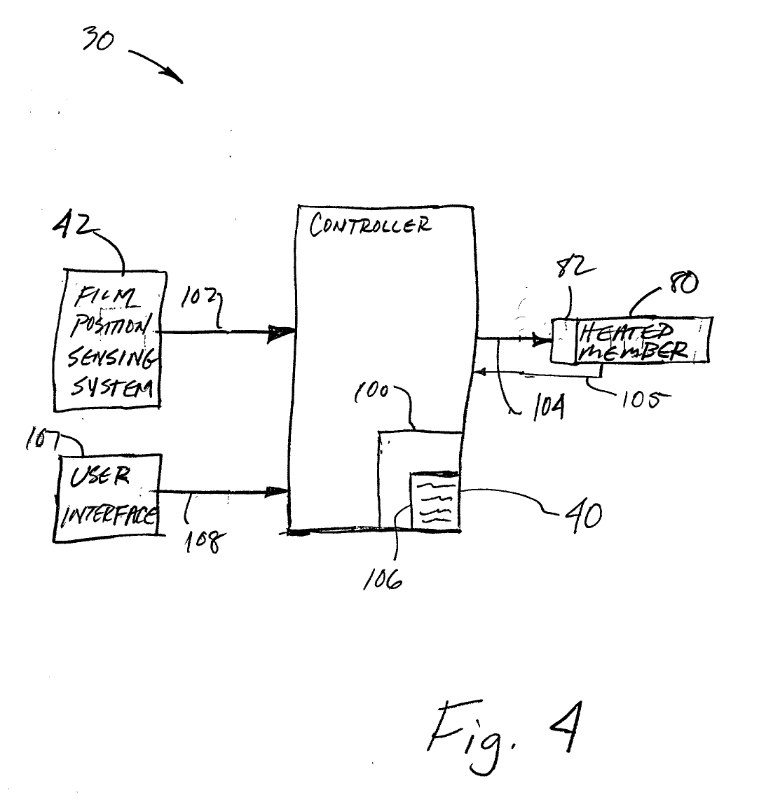

In FIG. 4, one exemplary embodiment of a thermal processor control system 30 used in the temperature compensation system in accordance with the present invention is shown. The control system 30 includes film position detection system 42 and controller 40 having memory 100. Memory 100 preferably comprises a non-volatile memory and in one preferred embodiment is an erasable programmable read-only memory (EPROM). In operation, film position detection system 42 provides and output signal 102 to controller 40. Output signal 102 is representative of the position of the thermally processable material 34 along the transport path 35 as it moves through thermal processor 20. In response to output position signal 102 controller 40 accesses a computer program stored in memory 100 (i.e., firmware) for determining an output signal 104 provided to heater 82, changing the temperature of heated member 80. In one embodiment, a temperature sensing device, such as a resistance thermo device (RTD) or thermocouple it is positioned on heater 82 or heated member 80 for providing an output signal 105 to controller 40 representative of the temperature of the heated member 84 or heater 82. In firmware, controller 40 compares the output signal 105 to predetermined temperature set points stored in memory 100 based on the position of the thermally processable material 34 along the transport path 35. Controller 40 provides the corresponding output signal 104 to heater 82 based on those set points (e.g., activation of a heater reach a temperature set point). If it is determined that an increase in temperature of the heated member 80 is desired, controller 40 can make corresponding changes to the predetermined set point. In another application, after calibration of the control system 30 including controller 40, heater 82 and heated member 80, the zero point or off-set in software may be changed such that the temperature of heated member 80 is increased or decreased the desired amount. In one alternative application, based on the known length of film and output position signal 102, controller 40 accesses a table 106 stored in memory 100 and retrieves values corresponding to the desired temperature change or increased temperature of heated member 80. The desired temperature set points may also be changed via user interface 107 (e.g., monitor and/or keyboard/keypad) which provide a representative output 108 to controller 40.

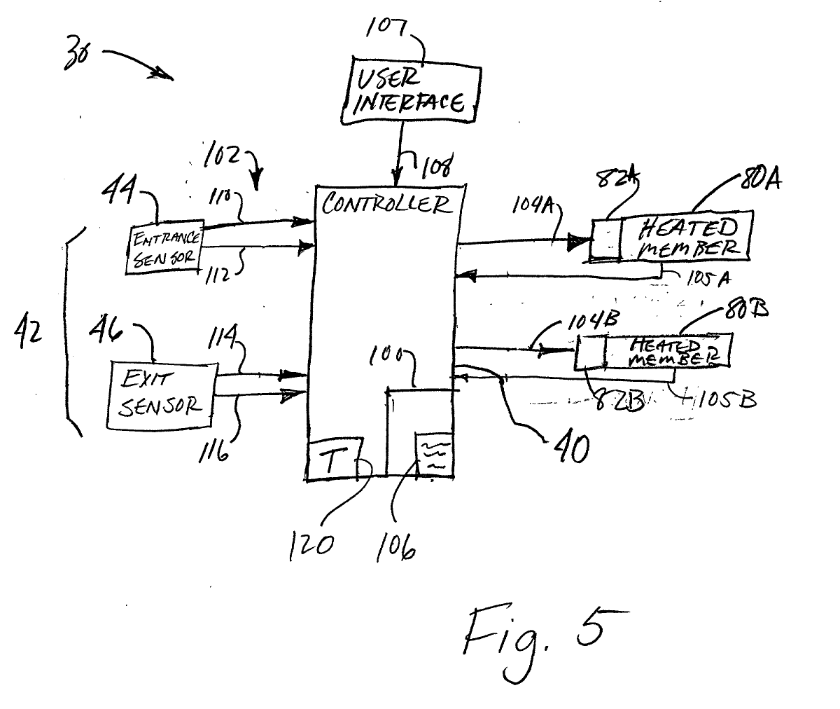

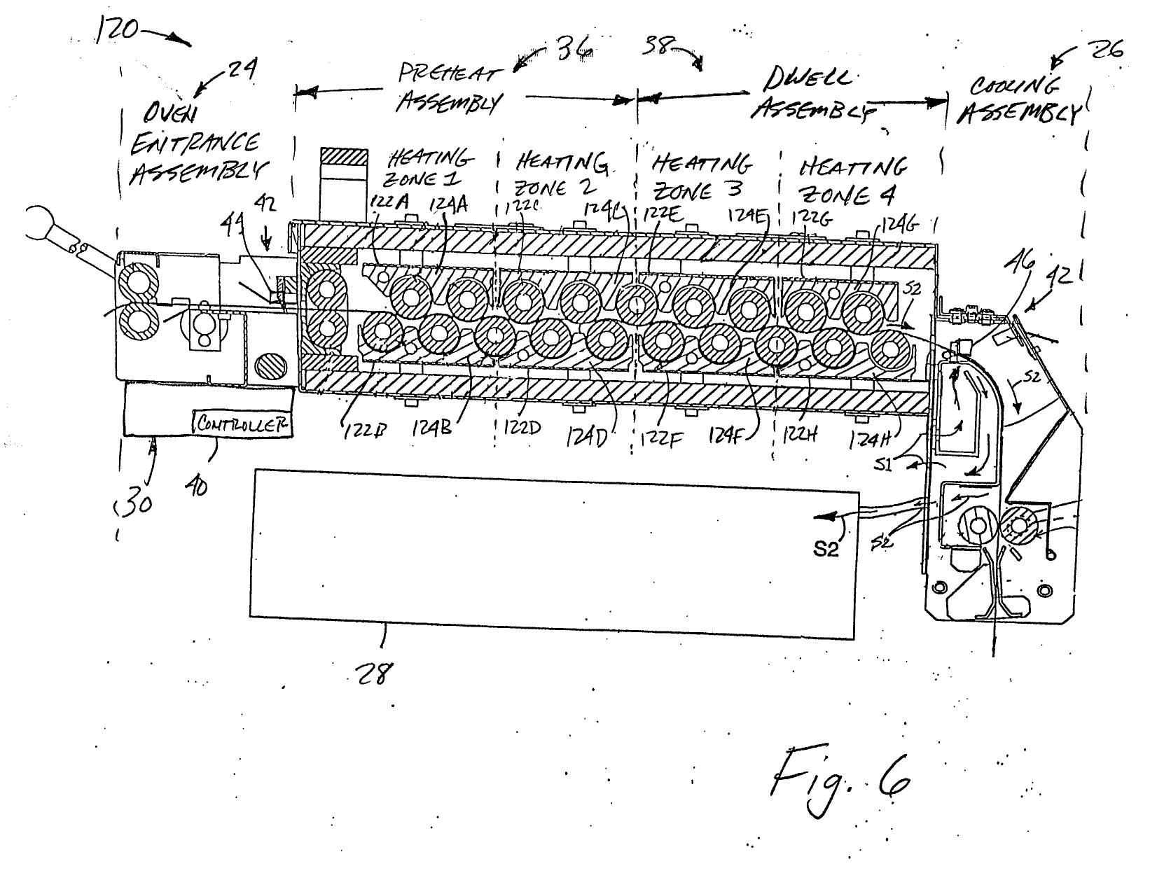

In FIG. 5, one preferred embodiment of a thermal processor control system used in a temperature compensation system in accordance with the present invention which is similar to the control system 30 previously described herein, is indicated at 30A. As also shown in FIG. 1, film position detection system 42 includes entrance sensor 44 and exit sensor 46. Entrance sensor 44 provides a first output signal 110 to controller 40 representative of the leading edge of the thermally processable material 34 entering the oven 22 preheat assembly 36. Entrance sensor 48 provides a second output signal 112 representative of the trailing edge of thermally processable material 34 entering the oven 22 preheat assembly 36. Similarly, exit sensor 46 provides an out signal 114 to controller 40 representative of the leading edge of the thermally processable material 34 exiting the oven 22. Exit sensor 46 can provide a second output signal 116 to controller 40 representative of the trailing edge of the thermally processable material 34 leaving oven 22. In response to the respective output signals 110, 112, 114, 116, controller 40 accesses a program in memory 100 for determining the desired change in temperatures to heated members 80A, 80B, in the preheat assembly 36. Signals 105A, 105B are provided to controller 40 representative of the temperatures of heated members 80A, 80B respectively. Accordingly, the output signal 104A, 104B is provided to heating elements 82A, 82B representative of the desired change in temperature to heated members 80A, 80B, in response to the corresponding signals 110, 112, 114, 116.

Controller 40 may further include timer 120 (T). Timer 120 defines a recovery period for thermal processor 20 between processing sheets of thermally processable material 34. As such, after exit sensor 46 provides output signal 116 to controller 40 representative of the trailing edge of thermally processable material 34 leaving oven 22, timer 120 operates to restrict processing of the next sheet or galley of thermally processable material until a desired length of time has expired. In one application, the required amount of time between processing sheets of thermally processable material 34 is, apparently one minute. Timer 120 may comprise a known timing mechanism, such as a clock or crystal, or may be controlled through a computer program stored in memory 100. In response to output 104, the temperature of heated members 80A, 80B is changed a desired (pre-programmed) amount to compensate for the temperature losses in the preheat assembly 36.

In FIG. 6, one alternative embodiment of a thermal processor 20 employing a temperature compensation system in accordance with the present invention is shown at 120. The thermal processor 120 is similar to the thermal processor 20 previously described herein, but further includes discrete and independently controllable HEATING ZONES indicates ZONES 1, ZONE 2, ZONE 3, ZONE 4. Utilizing the thermal processor control system 30 in accordance with the present invention, each HEATING ZONE 1, ZONE 2, ZONE 3 and ZONE 4 can be independently controlled to achieve a desired amount of heat transfer to thermally processable material 34 to maintain optical densities in a length of thermally processable material. It is noted that in FIG. 6 some of the reference numerals have been left off for clarity.

As shown, HEATING ZONE 1 and HEATING ZONE 2 are located in preheat assembly 36, and HEATING ZONE 3 and HEATING ZONE 4 are located in dwell assembly 38. HEATING ZONE 1 includes blanket heater 122a coupled to heated member 124a; and blanket heater 122b coupled to heated member 124b. HEATING ZONE 2 includes blanket heater 122c coupled to heated member 124c; and blanket heater 122d coupled to heated member 124d. HEATING ZONE 3 includes blanket heater 122e coupled to heated member 124e; and blanket heater 122f coupled to heated member 124f HEATING ZONE 4 includes blanket heater 122g coupled to heating member 124g; and blanket heater 122h coupled to heating member 124h.

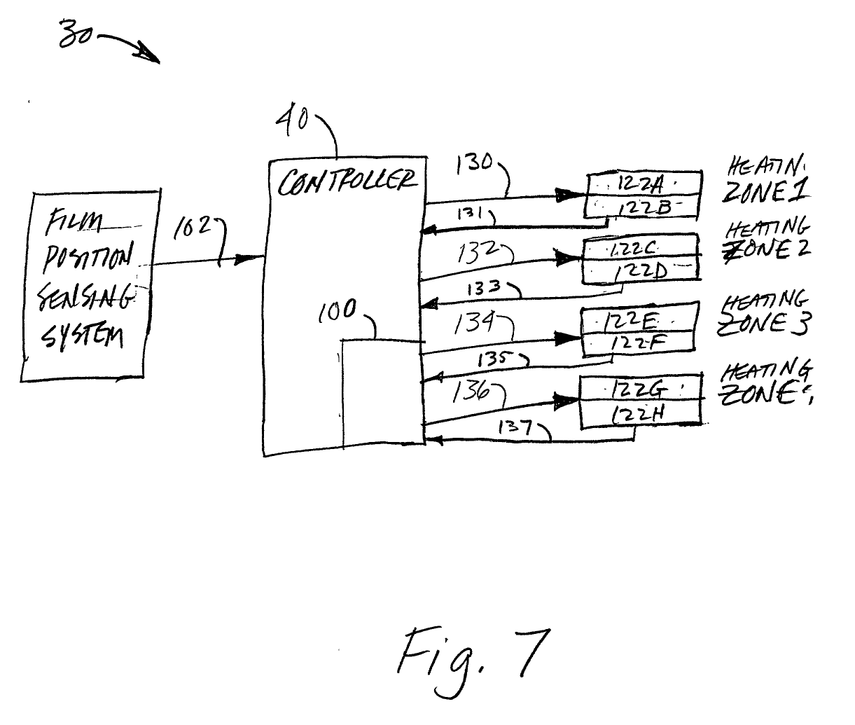

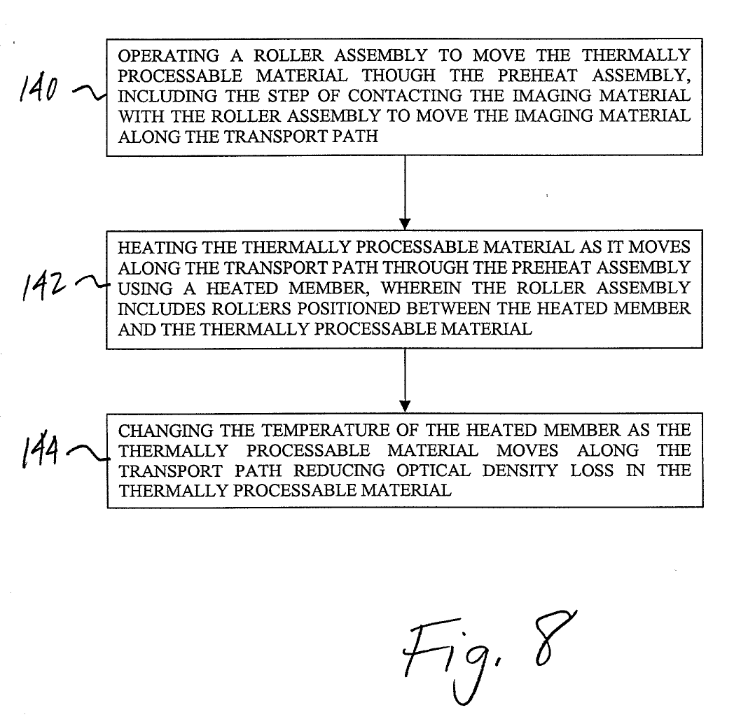

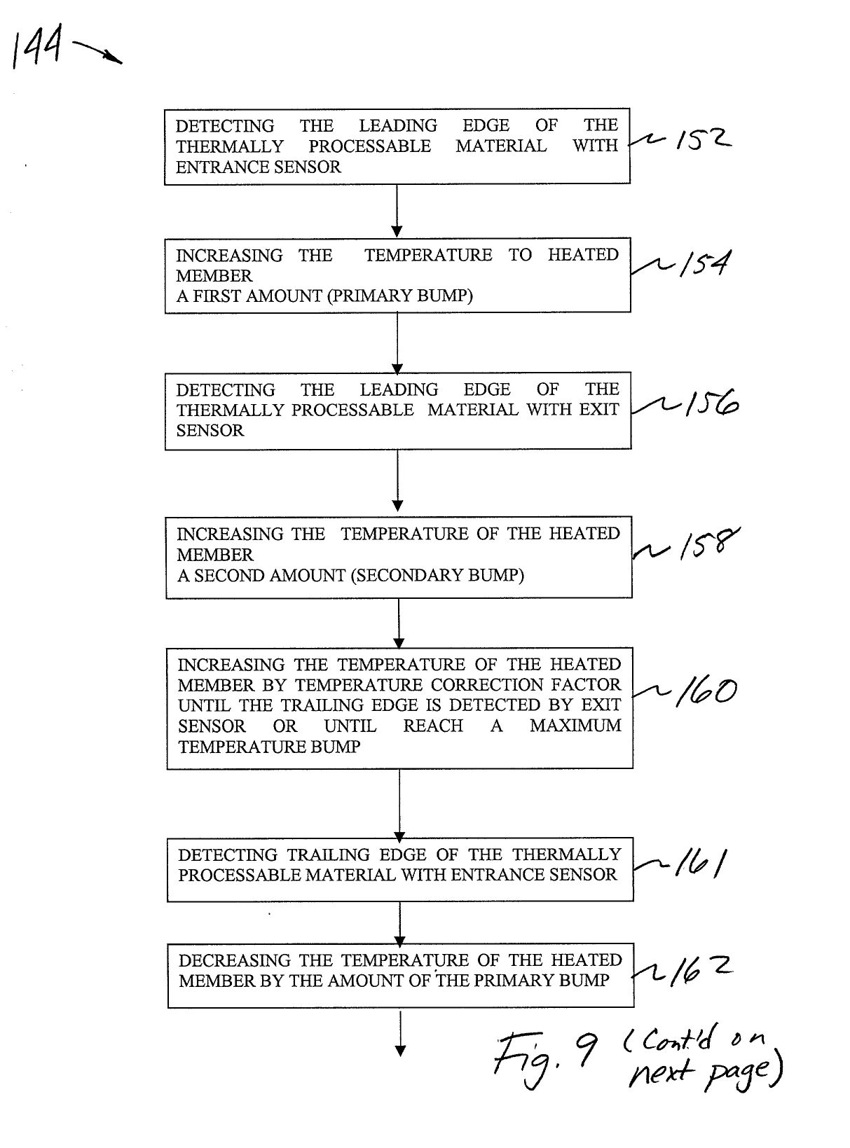

In FIG. 7, a block diagram illustrating one exemplary embodiment of a thermal processor control system 130 used with the thermal processor 120 of FIG. 6 as illustrated. Thermal processor control system 130 is similar to the thermal processor control system 30 previously described herein. As previously described herein, film position detection system 42 provides a output signal 102 to controller 40 representative of the position of the thermally processable material 34 along the transport path 35. In response to the position output signal 102 controller 40 provides an output signal 130 to blanket heaters 122a, 122b of the ZONE 1, output signal 132 to blanket heaters 122c, 122d of ZONE 2; output signal 134 to blanket heaters 122e, 122f of ZONE 3; and output signal 136 to blanket heater 122g, 122h of ZONE 4. The output signals 130, 132, 134 and 136 are representative of the desired temperature change to each independent ZONE 1, ZONE 2, ZONE 3 and ZONE 4 and corresponding output signals 131, 133, 135 and 137 representative of the temperature of corresponding heaters 122A, 122B, 122C, 122D, 122E, 122F, 122G, 122H and/or their heated members, thereby allowing independent regulation of the temperature within each HEATING ZONE, such that the desired processing temperature control can be achieved.

Referring to FIG. 8, and also the figures previously described herein, a flow diagram illustrating one method for developing an image in a thermally processable material employing a temperature compensation system in accordance with the present invention is shown. The thermally processable material is transported along a transport path through a thermal processor. The thermal processor includes a preheat assembly for preheating the thermally processable material to a threshold temperature, and a dwell assembly for thermal development of the image in the thermally processable material. The thermally processable material is defined by a leading edge and a trailing edge. At 140, the method includes the step of operating the a roller assembly to move the thermally processable material through the preheat assembly, including the step of contacting the thermally processable material with the roller assembly to move the thermally processable material along the transport path. In step 142, the thermally processable material is heated as it moves along the transport path through the preheat assembly using a heated member, wherein the roller assembly includes rollers positioned between the heated member and the thermally processable material. In step 144, the temperature of the heated member is changed as the thermally processable material moves along the transport path reducing optical density loss in the thermally processable material.

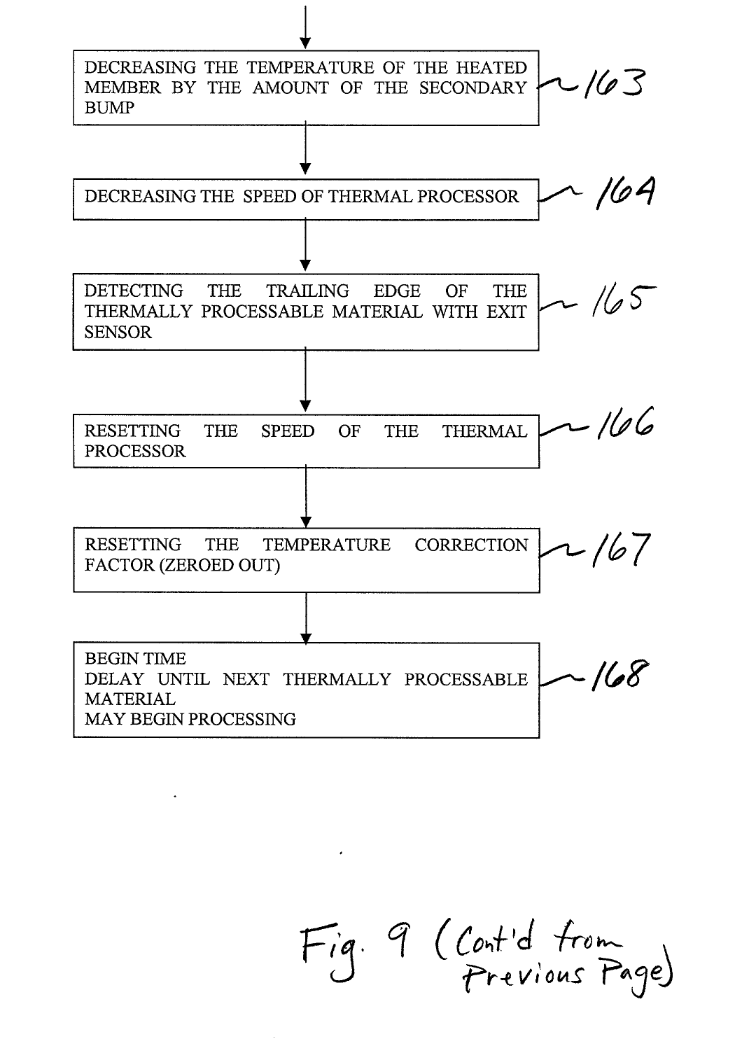

In FIG. 9, a flow diagram illustrating one exemplary embodiment of the method changing the temperature of the heated member as the imaging material moves along the transport path reducing optical density loss in the imaging material is illustrated. Reference is also made to FIG. 1. In step 152, the leading edge of the thermally processable material 34 is detected with the entrance sensor 44. In step 154, the thermal processor control system 30 operates to increase the temperature to the heated member 80 a first amount (termed a “primary bump”). In step 156, the leading edge of the thermally processable material 34 is detected by exit sensor 46. In step 158, the temperature to the heated member 80 is increased a second amount (termed a “secondary bump”).

At step 160, also in response to detecting the leading edge of the thermally processable material 34 with the exit sensor 46, the temperature to the heated member is increased by a predetermined temperature correction factor until the trailing edge is detected by exit sensor 46 or until a maximum temperature bump is reached. In one embodiment, the temperature correction factor increases the temperature to the heated member by a fixed amount per linear foot of thermally processable material 34 processed. In step 161, the trailing edge of the thermally processable material 34 is detected with entrance switch 44. In step 162, the temperature of the heated member is decreased by the amount of the primary bump. Additionally, in step 163, the temperature of the heated member is decreased by the amount of the secondary bump. Next, in step 164, the speed of the thermal processor is decreased due to the increased speed of the pair of rollers in cooling assembly 26 as previously described herein. In step 165, the trailing edge of the thermally processable material 34 is detected with the exit sensor 46. In step 166, in response to detection of the trailing edge by exit sensor 46, the speed of the thermal processor is reset, and in step 167, the temperature correction factor is reset (zeroed out). After completion of thermal processing of thermally processable material 34, in step 168 a time delay (as previously described herein) is initiated to allow the thermal processor to recover before the next thermally processable material may be processed using thermal processor 20.

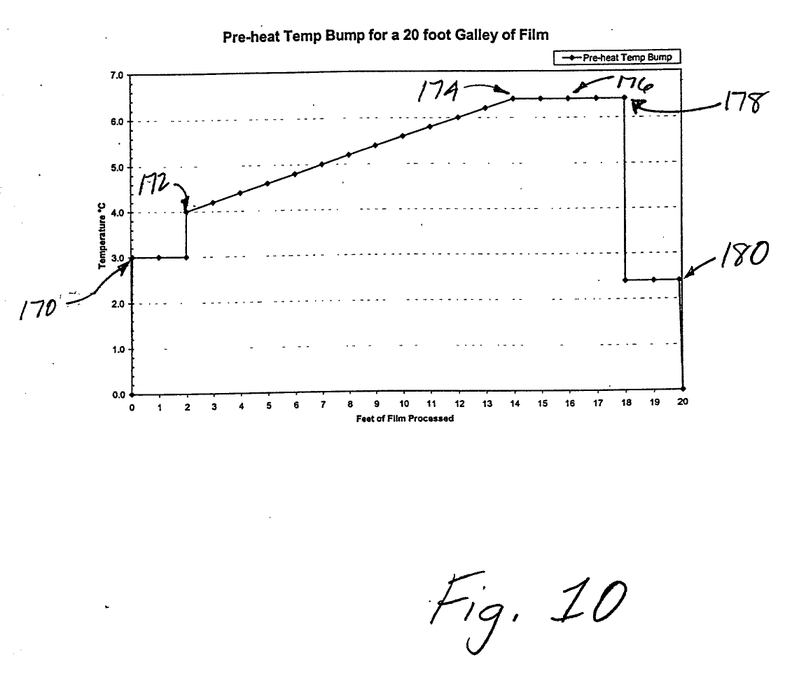

In FIG. 10, a graph of temperature (° C.) versus feet of film processed is shown illustrating an example using the method of FIG. 9. At 170, the leading edge of the thermally processable material 34 triggers the entrance sensor 44. At that time, the primary bump is added to the heated member 80. In the example shown, the primary bump temperature adjustment is 3° C. When the lead edge of the thermally processable material is sensed by exit sensor 46, the secondary bump is added to the heated member. In the example shown, the secondary bump is 1° C., indicated at 152. Further, when the lead edge of the film is sensed by the exit sensor 46, the temperature correction factor is added to the heated member 84 each foot of thermally processable material that gets processed. The temperature correction continues to increase until either the tail edge of the thermally processable material 34 is sensed by the exit sensor 46 or until the overall temperature increase (the primary bump plus the secondary bump plus the temperature correction) reaches a maximum increase or bump value. In the example shown, the temperature correction factor is equal to 0.22 degrees Celsius per foot of processed thermally processable material, and the maximum bump value is 6.4 degrees Celsius (indicated at 174). At 176, a constant temperature is maintained, since the maximum bump value is reached. Accordingly, there is no more addition of heat due to the temperature correction factor.

Further, when the trailing end of the thermally processable material 34 is detected by the entrance sensor 44, the value of the secondary bump is subtracted from the heated member. Additionally, the speed of the thermal processor is decreased by a desired amount (termed “tail-end speed correction”). In the example shown, the tail end speed correction was 0.15 inches per second. Additionally, when the trailing edge of the thermally processable material is 34 is detected by the entrance sensor 44, the primary bump is also subtracted from the heated member, indicated at 178. When the trailing edge of the thermally processable material 46 is detected by the exit sensor 46, the processor speed is reset to its initial speed, and the temperature correction factor is reset (zeroed out), indicated at 180.

The time delay between processing of the next thermally processable material is defined by the minimum amount of time to wait before the next sheet of thermally processable material can start processing without effecting the quality of the imaged developed in the thermally processable material. The time delay beings when the thermally processable material exits the thermal processor completely. In the example of FIG. 10, a desired time delay of 1 minute was determined to allow for sufficient recovery time of the thermal processor. The temperature compensation system illustrated by FIG. 10 maintains desired optical densities in the developed image for a 20 foot galley of film.

The system and method in accordance with the present invention may be extended to other types of thermal processors, such as drum based system. The thermo processor system and method in accordance with the present invention maintains the optical density of the processed image in long lengths of imaging material or film by increasing the temperature in the preheat assembly as the imaging material is processed therethrough, to compensate for temperature losses in the system. It is contemplated that other methods of temperature compensation may be employed, such as heating the roller assemblies themselves as opposed to a heated member positioned adjacent thereto. Further, it is contemplated that the temperature of the heated members may be increased by increasing the heat supplied by the blanket heaters, or alternatively by other methods, such as activation of auxiliary heaters or blanket heater positioned within the preheat assembly. Numerous characteristics and advantages of the invention have been set forth in the foregoing description. It will be understood, of course, that this disclosure is, in many respects, only illustrative. Changes can be made in details, particularly in matters of shape, size, and arrangement of parts without exceeding the scope of the invention. The invention scope is defined in the language in which the appended claims are expressed.

What is claimed is:

1. A thermal processor for use in developing an image in a thermally processable material which is transported along a transport path through the thermal processor, the thermal processor comprising:
a preheat assembly for preheating the thermally processable material to a threshold temperature, including a heated member having a major surface facing the thermally processable material;
a dwell assembly for thermal development of the image in the thermally processable material;
means for moving the thermally processable material along the transport path through the preheat assembly and the dwell assembly, including a roller assembly which contacts the thermally processable material, and wherein the roller assembly includes rollers positioned between the heated member and the thermally processable material; and
means for reducing optical density loss in the thermally processable material, including means for selectively changing the temperature of the heated member as the thermally processable material moves along the transport path.

2. The processor of claim 1, wherein the rollers are nested within the heated member.

3. The processor of claim 1, wherein the rollers include a coating made of silicone.

4. The processor of claim 1, wherein the means for selectively changing the temperature of the heated member includes means for selectively increasing the temperature of the heated member as the thermally processable material moves along the transport path, allowing the thermally processable material to reach the threshold temperature at the proper time.

5. The processor of claim 1, wherein the means for selectively changing the temperature of the heated member includes:
a position sensing system having an output signal representative of the position of the thermally processable material as it moves along the transport path;
a controller responsive to the position output signal for selectively changing the temperature of the heated member.

6. The processor of claim 5, wherein the controller includes a table stored in memory, wherein the table includes values corresponding to a desired change in temperature of the heated member based on the position output signal.

7. The processor claim 1, wherein the means for selectively changing the temperature of the heated member includes a computer program stored in memory.

8. The processor of claim 5, wherein the thermally processable material includes a leading edge and a trailing edge, the position sensing system further includes a first sensor having a first output signal representative of the position of the leading edge of the thermally processable material along the transport path.

9. The processor of claim 5, wherein the thermally processable material includes a leading edge and a trailing edge, the position sensing system further including an entrance sensor having a first output signal representative of the leading edge entering the thermal processor, and a second output signal representative of the trailing edge entering the thermal processor.

10. The processor of claim 9, the position sensing system further including an exit sensor having a first output signal representative of the leading edge exiting the thermal processor and a second output signal representative of the trailing edge exiting the thermal processor.

11. A method for developing an image in a thermally processable material transported along a transport path through a thermal processor, the thermal processor including a preheat assembly for preheating the thermally processable material to a threshold temperature, and a dwell assembly for thermal development of the image in the thermally processable material, the thermally processable material defined by a leading edge and a trailing edge, the method comprising the steps of:
Operating a roller assembly to move the thermally processable material through the preheat assembly, including the step of contacting the thermally processable material with the roller assembly to move the thermally processable material along the transport path;
Heating the thermally processable material as it moves along the transport path through the preheat assembly using a heated member, wherein the roller assembly includes rollers positioned between the heated member and the thermally processable material; and
Changing the temperature of the heated member as the thermally processable material moves along the transport path reducing optical density loss in the thermally processable material.

12. The method of claim 11, further comprising the step of nesting the rollers within the heated member, without contacting the heated member.

13. The method of claim 11 wherein the step of changing the temperature of the heated member includes the step of increasing the temperature of the heated member as the thermally processable material moves along the transport path, allowing the thermally processable material to reach the threshold temperature at the proper time.

14. The method of claim 11, further comprising the step of sensing the position of the thermally processable material using a position sensing system as the thermally processable material moves along the transport path;
providing a position output signal representative of the position of the thermally processable material along the transport path to a processor control system; and
changing the temperature of the heated member in response to the position output signal.

15. The method of claim 14, wherein the step of changing the temperature of the heated member includes the step of storing a table in memory in the processor control system, wherein the table includes values correlating a desired change in temperature of the heated member based on the sensed position output signal.

16. The method of claim 14, wherein the step of changing the temperature of the heated member in response to the position output signal includes the step of accessing a computer program stored in memory in the processor control system.

17. The method of claim 14, wherein the step of sensing the position of the thermally processable material includes the steps of providing an entrance sensor having an output signal representative of the position of the leading edge as it enters the thermal processor.

18. The method of claim 14, wherein the step of sensing the position of the thermally processable material includes the step of providing an entrance sensor having a first output signal representative of the position of the leading edge of the thermally processable material entering the thermal processor and a second output signal representative of the position of the trailing edge of the thermally processable material entering the thermal processor.

19. The method of claim 18, wherein the step of sensing the position of the thermally processable material further includes the step of providing an exit sensor having a first output signal representative of the leading edge exiting the thermal processor and a second output signal representative of the trailing edge exiting the thermal process.

20. A thermal processor for use in developing an image in a thermally processable material which is transported along a transport path through the thermal processor, the thermal processor comprising:
A preheat assembly for preheating the thermally processable material to a threshold temperature, including a first heated member having a major surface facing the thermally processable material;
A transport system including a roller assembly positioned about the thermally processable material which contacts the thermally processable material for moving the thermally processable material along the transport path, the roller assembly including a plurality of rollers positioned between the first heated member and the thermally processable material; and
A thermal processor control system operably coupled to the first heated member and the transport system, the thermal processor control system including a controller for selectively changing the temperature of the heated member as the thermally processable material moves along the transport path.

21. The thermal processor of claim 20, wherein the rollers are coated with foam.

22. The thermal processor of claim 20, wherein the rollers are silicone coated.

23. The thermal processor of claim 20, wherein the rollers which contact the thermally processable material are spaced from the heated member.

24. The thermal processor of claim 20, further comprising a second heated member located adjacent the first heated member, wherein the first heated member and the second heated member are heated independent of each other.

25. The thermal processor of claim 20, wherein the thermal processor is a flat bed processor.

26. The thermal processor of claim 20, further comprising an entrance sensor, wherein the entrance sensor provides an output signal to the controller representative of the position of the thermally processable material along the transport path.

27. The thermal processor of claim 26, wherein the output signal includes a first output signal representative of the leading edge of the thermally processable material entering the thermal processor and a second output signal representative of the trailing edge of the thermally processable material entering the thermal processor.

28. The thermal processor of claim 27, further wherein the controller is responsive to the first output signal for increasing the temperature of the heated member.

29. The thermal processor of claim 27, wherein the controller is responsive to the second output signal for decreasing the temperature of the heated member.

30. The thermal processor of claim 20, further comprising an exit sensor, wherein the exit sensor provides an output signal to the controller representative of the position of the thermally processable material along the transport path.

31. The thermal processor of claim 30, wherein the output signal includes a first output signal representative of the leading edge of the thermally processable material exiting the thermal processor.

32. The thermal processor of claim 31, wherein the controller is responsive to the first output signal for increasing the temperature of the heated member.

33. The thermal processor of claim 31, wherein the output signal includes a second output signal representative of the trailing edge of the thermally processable material exiting the thermal processor.

34. The thermal processor of claim 33, wherein the controller is responsive to the second output signal for decreasing the temperature of the heated member.
